(19) United States
(12) Patent Application Publication
(10) Pub. No.: US 2025/0059053 A1
(43) Pub. Date: Feb. 20, 2025

(54) SILICA PARTICLE DISPERSION LIQUID

(71) Applicants: AGC INC., Tokyo (JP); AGC SI-TECH CO., LTD., Kitakyushu-shi (JP)

(72) Inventor: Hiromichi KAMO, Tokyo (JP)

(73) Assignees: AGC INC., Tokyo (JP); AGC SI-TECH CO., LTD., Kitakyushu-shi (JP)

(21) Appl. No.: 18/938,417

(22) Filed: Nov. 6, 2024

Related U.S. Application Data
(63) Continuation of application No. PCT/JP2023/016363, filed on Apr. 25, 2023.

(30) Foreign Application Priority Data
May 9, 2022 (JP) 2022-077092

(51) Int. Cl. C01B 33/18; C08K 7/26

(52) U.S. Cl. CPC C01B 33/18; C08K 7/26; C01P 2004/34; C01P 2004/61; C01P 2004/62; C01P 2006/10; C01P 2006/12; C01P 2006/22; C08K 2201/005; C08K 2201/006

(57) ABSTRACT

The present invention relates to a silica particle dispersion including: hollow silica particles; and a solvent, in which the hollow silica particles have an average particle diameter in a range of 0.2 μm to 10 μm. The present invention relates to the silica particle dispersion in which the hollow silica particles have a particle density of 0.35 g/cm³ to 2.00 g/cm³, the particle density being determined by density measurement with a dry pycnometer using argon gas.

### CROSS-REFERENCE TO RELATED APPLICATIONS

This is a continuation of International Application No. PCT/JP2023/016363 filed on Apr. 25, 2023, and claims priority from Japanese Patent Application No. 2022-077092 filed on May 9, 2022, the entire content of which is incorporated herein by reference.

### TECHNICAL FIELD

The present invention relates to a silica particle dispersion in which silica particles are dispersed in a solvent.

### BACKGROUND ART

In related art, silica particles have been used for various applications, such as electronic materials for printed wiring boards or package wiring boards, optical materials for lenses or optical films, functional materials for catalysts or catalyst carriers, and pigments for paints or cosmetics. Among them, hollow silica particles have properties such as a low refractive index, a low permittivity, and a low density, and thus are used for lowering a relative permittivity, lowering dielectric loss tangent, and lowering thermal expansion of an insulating resin sheet such as an adhesive film or a prepreg, and a resin composition used for an insulating layer formed on a printed wiring board.

Since the silica particles are likely to aggregate when used in a dry powder state, the silica particles are used in the form of a dispersion in which the silica particles are dispersed in a solvent such as water or a resin according to intended use, and various silica particle dispersions and slurries containing the silica particle dispersions have been proposed.

For example, Patent Literature 1 has proposed an electronic material slurry including an electronic material filler that is a silica particle material and a liquid dispersion medium that does not substantially contain water, the silica particle material having a particle diameter of 100 nm to 2,000 nm or a specific surface area of 2 m²/g to 35 m²/g, and an amount of water generated when heated at 200° C. of 40 ppm or less per 1 m² of surface area, and being subjected to surface treatment with a silane compound having a vinyl group, a phenyl group, a phenylamino group, an alkyl group having 4 or more carbon atoms, a methacrylic group, or an epoxy group.

Patent Literature 2 has proposed an anti-reflection film-forming coating liquid including silica-based hollow fine particles (A) having an average particle diameter (Dpa) in a range of 30 nm to 200 nm, silica solid fine particles (B) having an average particle diameter (Dpb) in a range of 5 nm to 80 nm, and a solvent, in which a concentration (CA) of the silica-based hollow fine particles (A) is in a range of 0.2 wt % to 8 wt % in terms of solid content, a concentration (CB) of the silica solid fine particles (B) is in a range of 0.2 wt % to 8 wt % in terms of solid content, and a weight ratio (B/A) of the silica solid fine particles (B) to the silica-based hollow fine particles (A) is 0.25 to 4.

Patent Literature 3 has proposed a silica-based particle dispersion containing silica-based particles having an average particle diameter of 5 to 40 nm and having a proportion (hollow ratio) of the number of hollow particles to the total number of hollow particles and solid particles of 70% or more.

### CITATION LIST

### Patent Literature

Patent Literature 1: JP2020-097498A
Patent Literature 2: JP2015-102666A
Patent Literature 3: JP2018-123043A

### SUMMARY OF INVENTION

### Technical Problem

However, when the silica particle dispersion in the related art is contained in a resin composition to form a film, the silica particles tend to become grainy, peel strength is low, and it is difficult to obtain an effect expected from the silica particles.

The present invention has been made in view of the above problems, and an object thereof is to provide a silica particle dispersion that can reduce graininess during film formation and increase peel strength.

### Solution to Problem

The present invention relates to the following (1) to (11).

(1) A silica particle dispersion including: hollow silica particles; and a solvent, in which the hollow silica particles have an average particle diameter in a range of 0.2 μm to 10 μm.

(2) The silica particle dispersion according to (1), in which the hollow silica particles have a particle density of 0.35 g/cm³ to 2.00 g/cm³, the particle density being determined by density measurement with a dry pycnometer using argon gas.

(3) The silica particle dispersion according to (1) or (2), the hollow silica particles have a particle density of 2.00 g/cm³ to 2.30 g/cm³, the particle density being determined by density measurement with a dry pycnometer using helium gas.

(4) The silica particle dispersion according to any one of (1) to (3), in which the hollow silica particles have a BET specific surface area of 1 m²/g to 100 m²/g.

(5) The silica particle dispersion according to any one of (1) to (4), in which the hollow silica particles have a sphericity of 0.75 to 1.0.

(6) The silica particle dispersion according to any one of (1) to (5), further including a silane compound having at least one group selected from the group consisting of a vinyl group, a phenyl group, a phenylamino group, an alkyl group having 4 or more carbon atoms, a methacrylic group, and an epoxy group.

(7) The silica particle dispersion according to any one of (1) to (6), further including an organic thixotropic agent.

(8) The silica particle dispersion according to any one of (1) to (7), in which the solvent includes at least one selected from the group consisting of water, hydrocarbons, alcohols, acetate esters, ketones, cellosolves, glycol ethers, chlorohydrocarbons, and polar solvents.

(9) The silica particle dispersion according to any one of (1) to (8), having a viscosity of 20 mPa·s to 20,000 mPa·s at 25° C. when a solid content concentration of the hollow silica particles is 50% by volume.

(10) A resin composition including the silica particle dispersion according to any one of (1) to (9).

(11) A method for producing a silica particle dispersion, the method including: mixing a solvent and powder of hollow silica particles having an average particle diameter in a range of 0.2 μm to 10 μm, and subjecting the mixed liquid to a dispersion treatment, followed by classifying to remove aggregates of the hollow silica particles.

### Advantageous Effects of Invention

In the silica particle dispersion of the present invention, since the hollow silica particles are uniformly dispersed in the liquid without being aggregated, it is possible to reduce graininess when the resin composition including the silica particle dispersion of the present invention is formed into a film, and to increase peel strength.

### DESCRIPTION OF EMBODIMENTS

The present invention will be described below, but the present invention is not limited to examples described below. In addition, in the present specification, an expression “to” used to express a numerical range includes numerical values before and after it as a lower limit value and an upper limit value of the range, respectively.

Moreover, in the present specification, “mass” is synonymous with “weight”.

### <Silica Particle Dispersion>

A silica particle dispersion of the present invention includes hollow silica particles and a solvent, in which the hollow silica particles have an average particle diameter in a range of 0.2 μm to 10 μm. In the silica particle dispersion of the present invention, the hollow silica particles are uniformly dispersed without being aggregated, dispersion stability of the hollow silica particles in the dispersion is improved, it is possible to reduce graininess when the silica particle dispersion is included in a resin composition to form a film, and peel strength can be increased.

### (Solvent)

A solvent serving as a dispersion medium of the silica particle dispersion may be freely selected according to intended use, and examples thereof include water, hydrocarbons, alcohols, acetate esters, ketones, cellosolves, glycol ethers, chlorohydrocarbons, and polar solvents. The solvent preferably includes at least one selected from the group consisting of these solvents.

Examples of the hydrocarbons include toluene, methylcyclohexane, normal heptane, and m-xylene. Examples of the alcohols include ethanol, isopropyl alcohol, 1-propyl alcohol, isobutyl alcohol, 1-butanol, and 2-butanol. Examples of the acetate esters include propyl acetate, isobutyl acetate, and butyl acetate. Examples of the ketones include methyl ethyl ketone, methyl isobutyl ketone, and cyclohexanone. Examples of the cellosolves include ethylene glycol monomethyl ether and ethylene glycol monoethyl ether. Examples of the glycol ethers include 1-methoxy-2-propanol, 1-methoxypropyl-2-acetate, 1-ethoxy-2-propanol, and ethyl 3-ethoxypropionate. Examples of the chlorohydrocarbons include trichloroethylene and tetrachloroethylene. Examples of the polar solvents include N-methyl-2-pyrrolidone.

The solvent may be appropriately selected according to the field of intended use. For example, when used for an insulating layer of a wiring board of an electronic device, ketones and hydrocarbons are preferably used, and specifically, methyl ethyl ketone (MEK), toluene, and the like are preferably used.

When the silica particle dispersion of the present invention is used in a curable composition, a liquid main agent or a curing agent itself may be used as a solvent. Examples of the main agent include epoxy resins, polyphenylene ether resins, polyester resins, polyimide resins, phenol resins, ortho-divinylbenzene resins, and the like. Examples of the curing agent include polyamine curing agents, acid anhydride curing agents, phenol curing agents, active ester curing agents, and peroxides.

The solvent is preferably included in a range of 20% by volume to 90% by volume in the silica particle dispersion. When a content of the solvent is 20% by volume or more, the hollow silica particles can be uniformly dispersed, and the viscosity of the dispersion is not too high, making it easy to handle. In addition, when the content of the solvent is 90% by volume or less, the silica particle dispersion is in a liquid state and thus can be used as it is in a dispersed state. The content of the solvent in the silica particle dispersion is more preferably 25% by volume or more, still more preferably 30% by volume or more, and is more preferably 80% by volume or less, still more preferably 70% by volume or less, particularly preferably 60% by volume or less, and most preferably 50% by volume or less.

### (Hollow Silica Particles)

The hollow silica particles are silica particles each including a shell layer (solid film) that includes silica, and having a space portion inside the shell layer. The fact that the hollow silica particles each have a space portion inside the shell layer can be confirmed by transmission electron microscope (TEM) observation or scanning electron microscope (SEM) observation. In the case of SEM observation, by observing partially opened broken-particles, it can be confirmed that the particles are hollow.

The following physical properties of the hollow silica particles can be confirmed by drying the silica particle dispersion to obtain powdered silica particles.

In the present specification, the expression that the shell layer “includes silica” means that the shell layer includes 50% by mass or more of silica (SiO₂). A composition of the shell layer can be measured by ICP emission spectrometry or flame atomic absorption spectrometry. A content of the silica included in the shell layer is preferably 80% by mass or more, and more preferably 95% by mass or more. An upper limit thereof is theoretically 100% by mass. The content of the silica included in the shell layer is preferably less than 100% by mass, and more preferably 99.99% by mass or less. Examples of a residue include alkali metal oxides and silicates, alkaline earth metal oxides and silicates, and carbon.

In addition, the expression “having a space portion inside a shell layer” means a hollow state in which the shell layer surrounds the periphery of one space portion when a cross section of one primary particle is observed. That is, one hollow particle has one large space portion and a shell layer surrounding the space portion.

With the structure in which the hollow silica particles each have a space portion inside a shell, more spaces can be secured in a composition including the silica particle dispersion of the present invention, and when the composition is used for an insulating layer of an electronic device or the like, the permittivity can be decreased.

An average particle diameter (D50, median diameter) of the hollow silica particles dispersed in the silica particle dispersion of the present invention is 0.2 μm to 10 μm. Since primary particles in the hollow silica particles are partially bonded to each other in a step of baking or drying during production, the hollow silica particles are often aggregates of secondary particles in which the primary particles are aggregated. Here, the average particle diameter of the hollow silica particles refers to a particle diameter of the secondary particles, and the primary particles refer to spherical particles each having a space portion therein, which can be confirmed by TEM observation or SEM observation.

When the average particle diameter (D50) of the hollow silica particles in the silica particle dispersion is in the range of 0.2 μm to 10 μm, the silica particle dispersion has a viscosity that is easy to handle and is less likely to become grainy during coating, so that the peel strength of the resin composition is appropriately maintained when the silica particle dispersion is used as the resin composition.

The average particle diameter (D50) is preferably 0.5 μm or more, more preferably 1 μm or more, and is preferably 8 μm or less, more preferably 6 μm or less, and further preferably 5 μm or less.

The average particle diameter of the hollow silica particles (particle diameter of the secondary particles) is preferably measured by laser scattering. The reason why an aggregation diameter is measured by SEM is that a boundary between particles is unclear and the dispersion in a wet state is not reflected. In addition, in the measurement using a Coulter counter, the electric field changes differ between hollow particles and solid particles, and it is difficult to obtain corresponding numerical values as compared with the solid particles.

The secondary particles in the hollow silica particles preferably have a coarse particle diameter (D90) of 1 μm to 30 μm. From the viewpoint of production efficiency, the coarse particle diameter is preferably 1 μm or more. On the other hand, in the case where the coarse particle diameter is too large, when the resin composition is formed into a film, the film becomes grainy, and thus the coarse particle diameter is preferably 30 μm or less. A lower limit of the coarse particle diameter is more preferably 3 μm or more, and most preferably 5 μm or more. An upper limit thereof is preferably 30 μm or less, more preferably 25 μm or less, still more preferably 20 μm or less, and most preferably 15 μm or less.

As described above, the coarse particle diameter is also determined by measuring the particle diameter of the secondary particles by laser scattering.

In addition, sizes of the primary particles of the hollow silica particles are determined by directly observing a particle diameter (diameter) by SEM observation, and an average value of the sizes of the primary particles (average primary particle diameter) is preferably in the range of 50 nm to 10 μm. When the average primary particle diameter is 50 nm or more, an increase in a specific surface area, an oil absorption value, and a pore volume is prevented, an increase in an SiOH amount and adsorbed water on a particle surface can be prevented, and thus the dielectric loss tangent is hardly increased. When the average primary particle diameter is 10 μm or less, handling as a filler is easy.

From the viewpoint of production reproducibility, a lower limit of the average primary particle diameter is more preferably 70 nm or more, and still more preferably 100 nm or more, and an upper limit thereof is more preferably 5 μm or less, and particularly preferably 3 μm or less.

Specifically, the average primary particle diameter of the hollow silica particles is determined by measuring the sizes of the primary particles in 100 particles from an SEM image and estimating a distribution of the sizes of the primary particles obtained by gathering the sizes to be a distribution of the sizes of the entire primary particles. By the SEM observation, a primary particle diameter of the particles that is difficult to deagglomerate can be directly measured.

The hollow silica particles of the present invention have the above-described average primary particle diameter, and 40% or more of all primary particles preferably have a particle diameter within the average primary particle diameter±40%. When the particle diameter of 40% or more of the particles is within the average primary particle diameter±40%, the size of the hollow silica particles becomes uniform, and thus defects of the shell of the hollow silica particles are hardly generated. It is more preferable that the particle diameter of 50% or more of the entire particles is within the average primary particle diameter 40%, it is still more preferable that the particle diameter of 60% or more of the entire particles is within the average primary particle diameter±40%, and it is particularly preferable that the particle diameter of 70% or more of the entire particles is within the average primary particle diameter±40%.

The hollow silica particles preferably have a particle density (hereinafter also referred to as Ar density) of 0.35 g/cm³ to 2.00 g/cm³, the particle density being determined by density measurement with a dry pycnometer using argon gas. When the Ar density is 0.35 g/cm³ or more, it is possible to prevent cracking of the particles in the dispersion, and since a difference in specific gravity between the dispersion and the resin is not too large, it is possible to improve dispersibility in the resin composition when the silica particle dispersion is mixed with the resin. When the Ar density is 2.00 g/cm³ or less, an effect of reducing the permittivity is likely to be exhibited, and thus the hollow silica particles can be preferably used as a material of an electronic device. The Ar density is more preferably 0.40 g/cm³ or more, and an upper limit thereof is more preferably 1.50 g/cm³ or less, and still more preferably 1.00 g/cm³ or less. Specifically, the Ar density is more preferably 0.35 g/cm³ to 1.50 g/cm³, and still more preferably 0.40 g/cm³ to 1.00 g/cm³.

The hollow silica particles preferably have a particle density (hereinafter also referred to as He density) of 2.00 g/cm³ to 2.30 g/cm³, the particle density being determined by density measurement with a dry pycnometer using helium gas. Since the helium gas permeates through fine voids, a density of the silica particles having a space inside is acquired, the density corresponding to a true density of a silica portion. When the He density is 2.00 g/cm³ or more, the silica particles are dense. Thus, when the silica particle dispersion is mixed with the resin and used, the peel strength of the resin composition is not reduced. Further, since an amount of residual silanol contained in the hollow silica particles is reduced, the dielectric loss tangent can be easily reduced. In order to obtain a siliceous substance having a He density exceeding 2.30 g/cm³, baking at a considerably high temperature is necessary, and the particles are easily broken. When the He density is 2.30 g/cm³ or less, the space included in the hollow silica particles can be maintained, and the Ar density does not deteriorate. The He density is more preferably 2.05 g/cm³ or more, and still more preferably 2.10 g/cm³ or more, and is more preferably 2.25 g/cm³ or less, and still more preferably 2.23 g/cm³ or less. Specifically, the He density is more preferably 2.05 g/cm³ to 2.25 g/cm³, and still more preferably 2.10 g/cm³ to 2.23 g/cm³.

An apparent density of the hollow silica particles can also be measured using a specific gravity bottle. A sample (hollow silica particles) and an organic solvent are put into a specific gravity bottle and left to stand at 25° C. for 48 hours, followed by measuring. Since it may take time for the organic solvent to permeate the hollow silica particles depending on denseness of the shell of the hollow silica particles, it is preferable to leave the sample and the organic solvent to stand for the above period of time. A measurement result of the method corresponds to a result of density measurement with the dry pycnometer using argon gas.

The apparent density of the hollow silica particles can be adjusted by adjusting the primary particle diameter and the thickness of the shell, and by changing the particle density, it is possible to adjust whether the particles precipitate in the solvent, continue to be dispersed, or float on the solvent. When it is desired to disperse the particles in the solvent, a density of the solvent and the apparent density of the particles are preferably close to each other. For example, when it is desired to disperse the particles in water having a density of 1.0 g/cm³, the apparent density of the particles is preferably adjusted to 0.8 g/cm³ or more and 1.2 g/cm³ or less.

The hollow silica particles preferably have a BET specific surface area of 1 m²/g to 100 m²/g. It is substantially difficult to set the BET specific surface area to less than 1 m²/g. When the BET specific surface area is too large, more resin or the like is adsorbed on a silica surface. However, when the BET specific surface area is 100 m²/g or less, an amount of adsorption of the resin or the like can be reduced, and an increase in the viscosity when a resin composition is formed can be prevented. The BET specific surface area is preferably 1 m²/g to 100 m²/g, more preferably 1 m²/g to 50 m²/g, still more preferably 1 m²/g to 20 m²/g, and most preferably 1 m²/g to 15 m²/g.

The BET specific surface area is measured by a multi-point method using nitrogen gas, by a specific surface area measuring apparatus (for example, “TriStar 113020” manufactured by SHIMADZU CORPORATION), with respect to the hollow silica particles dried to 50 mTorr at 230° C. as a pre-treatment.

The hollow silica particles preferably have the product (A×B) of the Ar density and the BET specific surface area of 1 m²/cm³ to 120 m²/cm³, where the Ar density is A (g/cm³) and the BET specific surface area is B (m²/g). A×B indicates a specific surface area per volume when the hollow silica particles are dispersed in the solvent. For example, when the hollow silica particles are added to the resin, A×B indicates a specific surface area of a portion occupied by the hollow silica particles in a predetermined volume in the resin. Since the hollow silica particles satisfy the above relation between the Ar density and the BET specific surface area, when a resin composition including the hollow silica particles is used for an insulating layer, the permittivity of the insulating layer can be decreased, and the dielectric loss can be decreased. Therefore, it is possible to provide a substrate that can sufficiently cope with a high-frequency circuit. When the viscosity of the resin composition is excessively increased, the dielectric loss tangent when the resin composition is used for the insulating layer may be deteriorated. However, when A×B is 120 m²/cm³ or less, the specific surface area of silica in the composition is small. Therefore, the viscosity of the composition is not excessively increased, and the deterioration of the dielectric loss tangent can be prevented. A×B is preferably 80 m²/cm³ or less, more preferably 40 m²/cm³ or less, and still more preferably 20 m²/cm³ or less. In addition, it is substantially difficult to produce particles in which A×B is smaller than the above range. A×B is preferably 2 m²/cm³ or more, more preferably 2.5 m²/cm³ or more, and still more preferably 3 m²/cm³ or more.

The hollow silica particles preferably have a sphericity of 0.75 to 1.0. When the sphericity is too low, a contact area with a member in contact with silica particles in a resin layer in the resin composition including the silica particle dispersion decreases, resulting in a decrease in peel strength, and thus the sphericity is preferably 0.75 or more.

The sphericity is represented by an average value obtained by measuring a longest diameter (DL) and a shortest diameter (DS) orthogonal to the longest diameter (DL) of any 100 particles in a photographic projection obtained by taking a photograph with a scanning electron microscope (SEM), and calculating a ratio (DS/DL) of the shortest diameter (DS) to the longest diameter (DL).

From the viewpoint of dispersibility and the like, the sphericity is more preferably 0.80 or more, still more preferably 0.82 or more, yet still more preferably 0.83 or more, particularly preferably 0.85 or more, even particularly preferably 0.87 or more, and most preferably 0.90 or more.

A shell thickness of the hollow silica particles is preferably 0.01 to 0.3 with respect to a diameter 1 of the primary particles. When the shell thickness is 0.01 or more with respect to the diameter 1 of the primary particles, the strength of the hollow silica particles can be maintained. When the ratio is 0.3 or less, the internal space portion is not too small, and the characteristics derived from a hollow shape can be exhibited.

The shell thickness is preferably 0.02 or more, more preferably 0.03 or more, and is more preferably 0.2 or less, still more preferably 0.1 or less, with respect to the diameter 1 of the primary particles.

Here, the shell thickness is determined by measuring a shell thickness of each particle with a transmission electron microscope (TEM).

Since the hollow silica particles each have a space portion inside, a substance can be enclosed in the particle. In the hollow silica particles of the present invention, since the shell layer is dense, it is difficult for various solvents to permeate therethrough. However, when the broken particles are present, the solvents permeate into the hollow silica particles. Thus, the oil absorption value varies depending on a proportion of the broken particles.

The oil absorption value of the hollow silica particles is preferably 15 mL/100 g to 1,300 mL/100 g. When the oil absorption value is 15 mL/100 g or more, the adhesion with the resin can be secured when the hollow silica particles are used in the resin composition. When the oil absorption value is 1,300 mL/100 g or less, the strength of the resin can be secured when the hollow silica particles are used in the resin composition, and the viscosity of the composition can be reduced.

When the oil absorption value is large, the viscosity increases. Therefore, the oil absorption value of the hollow silica particles is more preferably 1,000 mL/100 g or less, still more preferably 700 mL/100 g or less, particularly preferably 500 mL/100 g or less, and most preferably 200 mL/100 g or less. When the oil absorption value is too small, the adhesion between powder and the resin may deteriorate. Therefore, the oil absorption value is more preferably 20 mL/100 g or more.

From the relation between the proportion of the broken particles and the oil absorption value as described above, the oil absorption value can be adjusted by adjusting the proportion of the broken particles. Furthermore, since a space between the primary particles is also a space capable of holding oil, it is considered that the oil absorption value increases when the median diameter of the secondary particles in which the primary particles are aggregated is large, and the oil absorption value decreases when the median diameter of the secondary particles is small.

The hollow silica particles preferably include one or more kinds of metal M selected from the group consisting of Li, Na, K, Rb, Cs, Mg, Ca, Sr, and Ba. When the metal M is included in the hollow silica particle, the metal M acts as a flux during baking, the specific surface area decreases, and the dielectric loss tangent can be reduced.

The metal M is included between a reaction step and a washing step in the production of the hollow silica particles. For example, in the reaction step, the metal M can be included in the hollow silica particles by adding a metal salt of the metal M to a reaction solution for forming a silica shell or by washing a hollow silica precursor with a solution containing metal ions of the metal M before baking.

In the present invention, a concentration of the metal M included in the hollow silica particles is preferably 50 ppm by mass or more and 1% by mass or less. When a total concentration of the metal M is 50 ppm by mass or more, the condensation of bonded silanol groups is promoted by a flux effect during baking and remaining silanol groups are reduced, and thus the dielectric loss tangent can be reduced. When the concentration of the metal M is too high, the amount of components that react with silica to form silicate increases and the hygroscopicity of the hollow silica particles may deteriorate, and thus the concentration of the metal M is preferably 1% by mass or less. The concentration of the metal M is preferably 100 ppm by mass or more, more preferably 150 ppm by mass or more, and is preferably 1% by mass or less, more preferably 5,000 ppm by mass or less, and most preferably 1,000 ppm by mass or less.

The metal M can be measured by ICP emission spectrometry after adding perchloric acid and hydrofluoric acid to the hollow silica particles, igniting a mixture thereof, and removing silicon which is a main component.

In the case where alkali metal silicate is used as a silica raw material, an amount of a carbon (C) component derived from the raw material in a shell layer of the obtained hollow silica particles is smaller than that in the case where silicon alkoxide is used as the silica raw material.

A kneaded product including the hollow silica particles preferably has a viscosity of 20,000 mPa·s or less as measured by the following measurement method.

### (Measurement Method)

A kneaded product obtained by mixing 6 parts by mass of a boiled linseed oil and (6×A/2.2) parts by mass of the hollow silica particles where A (g/cm³) is a particle density determined by density measurement with a dry pycnometer using argon gas and kneading a resulting mixture at 2,000 rpm for 3 minutes is measured for 30 seconds at a shear rate of 1 s⁻¹ using a rotary rheometer to determine a viscosity at 30 seconds.

When the viscosity at the shear rate of 1 s⁻¹ of the kneaded product determined by the above measurement method is 20,000 mPa·s or less, an amount of a solvent added at the time of forming a film of and molding the resin composition including the hollow silica particles can be reduced, a drying rate can be increased, and productivity can be improved. In addition, in the case where a product of a density according to a particle diameter of silica powder and the specific surface area is large, the viscosity tends to increase when the silica powder is added to the resin composition. However, the hollow silica particles can prevent an increase in the viscosity of the resin composition because the product of the density and the specific surface area is small. The viscosity of the kneaded product is more preferably 8,000 mPa·s or less, still more preferably 5,000 mPa·s or less, and most preferably 4,000 mPa·s or less.

A lower limit value of the viscosity of the kneaded product at the shear rate of 1 s⁻¹ is not particularly limited because the lower the viscosity, the better coatability of the resin composition and the higher the productivity.

The silica particles are classified into four basic structures represented by Q1 to Q4 according to the connectivity of a SiO₄ tetrahedron in the assignment of a spectrum of ²⁹Si-NMR. Q1 to Q4 are as follows.

Q1 is a structural unit having one Si atom around Si via oxygen, has a SiO₄ tetrahedron connected to another SiO₄ tetrahedron, and thus has a peak in the vicinity of −80 ppm in a solid ²⁹Si-DD/MAS-NMR spectrum.

Q2 is a structural unit having two Si atoms around Si via oxygen, has a SiO₄ tetrahedron connected to the other two SiO₄ tetrahedra, and thus has a peak in the vicinity of −91 ppm in a solid ²⁹Si-DD/MAS-NMR spectrum.

Q3 is a structural unit having three Si atoms around Si via oxygen, has a SiO₄ tetrahedron connected to the other three SiO₄ tetrahedra, and thus has a peak in the vicinity of −101 ppm in a solid ²⁹Si-DD/MAS-NMR spectrum.

Q4 is a structural unit having four Si atoms around Si via oxygen, has a SiO₄ tetrahedron connected to the other four SiO₄ tetrahedra, and thus has a peak in the vicinity of −110 ppm in a solid ²⁹Si-DD/MAS-NMR spectrum.

In the hollow silica particles of the present invention, a molar ratio (Q3/Q4) of a Q3 structure having one OH group derived from a silanol group to a Q4 structure having no OH group derived from the silanol group as measured by solid ²⁹Si-DD/MAS-NMR is 2% to 40%. When Q3/Q4 is 40% or less, the amount of silanol can be reduced and the dielectric loss tangent is improved. To obtain hollow silica particles having Q3/Q4 of less than 2%, it is necessary to perform baking at a high temperature, and at this time, a hollow portion of the hollow silica shrinks, and thus it is substantially difficult to obtain hollow silica particles having Q3/Q4 of less than 2%. The Q3/Q4 is more preferably 30% or less, and still more preferably 20% or less.

The Q3/Q4 of the hollow silica particles is measured as follows.

Hollow silica particle powder is used as a measurement sample. A CPSAS probe having a diameter of 7.5 mm is attached to a 400 MHz nuclear magnetic resonance apparatus, an observation nucleus is set to ²⁹Si, and measurement is performed by a DD/MAS method. The measurement conditions are as follows: a ²⁹Si resonance frequency of 79.43 MHz, a ²⁹Si 90° pulse width of 5 s, a 1H resonance frequency of 399.84 MHz, a 1H decoupling frequency of 50 kHz, a MAS rotation speed of 4 kHz, a spectrum width of 30.49 kHz, and a measurement temperature of 23° C. In the data analysis, for each peak of a spectrum after Fourier transform, optimization calculation is performed by a nonlinear least squares method using a center position, a height, and a half width of a peak shape created by mixing a Lorentz waveform and a Gaussian waveform as variable parameters. For the four structural units Q1, Q2, Q3, and Q4, the molar ratio of Q3 and Q4 is calculated from the determined content of Q1, content of Q2, content of Q3, and content of Q4.

In the present embodiment, a content of the silanol groups in the silica particles is measured not by a Cross Polarization/Magic Angle Spinning method (CPSAS) but by a Dipolar Decoupling/Magic Angle Spinning method (DD/MAS).

In the CPSAS method, since ¹H sensitizes and detects Si existing in the vicinity thereof, the obtained peak does not accurately reflect the content of Q1, the content of Q2, the content of Q3, and the content of Q4.

On the other hand, since the DD/MAS method has no sensitizing effect like the CPSAS method, the obtained peak accurately reflects the content of Q1, the content of Q2, the content of Q3, and the content of Q4, and is suitable for quantitative analysis.

A pore volume of the hollow silica particles is preferably 0.2 cm³/g or less.

When the pore volume is 0.2 cm³/g or less, moisture is hardly adsorbed, and deterioration of the dielectric loss of the resin composition can be prevented. The pore volume is more preferably 0.15 cm³/g or less, still more preferably 0.1 cm³/g or less, and particularly preferably 0.05 cm³/g or less.

The surface of the hollow silica particles may be treated with a silane coupling agent.

When the surface of the hollow silica particles is treated with the silane coupling agent, an amount of silanol groups remaining on the surface is reduced, the surface is hydrophobized, and the dielectric loss can be improved by preventing water adsorption. Further, when the resin composition is prepared, affinity with the resin is improved, and dispersibility and strength after resin film formation are improved.

The conditions for the surface treatment are not particularly limited, and general surface treatment conditions may be used, and a wet treatment method or a dry treatment method may be used. From the viewpoint of performing a uniform treatment, a wet treatment method is preferable.

Examples of the silane coupling agent include aminosilane coupling agents, epoxysilane coupling agents, mercaptosilane coupling agents, silane-based coupling agents, and organosilazane compounds. The silane coupling agent may be used alone or in combination of two or more kinds thereof.

Specifically, examples of the silane coupling agent include an aminosilane coupling agent such as aminopropylmethoxysilane, aminopropyltriethoxysilane, ureidopropyltriethoxysilane, N-phenylaminopropyltrimethoxysilane, and N-2(aminoethyl)aminopropyltrimethoxysilane; an epoxysilane coupling agent such as glycidoxypropyltrimethoxysilane, glycidoxypropyltriethoxysilane, glycidoxypropylmethyldiethoxysilane, glycidylbutyltrimethoxysilane, and (3,4-epoxycyclohexyl)ethyltrimethoxysilane; a mercaptosilane coupling agent such as mercaptopropyltrimethoxysilane and mercaptopropyltriethoxysilane; a silane coupling agent such as methyltrimethoxysilane, vinyltrimethoxysilane, octadecyltrimethoxysilane, phenyltrimethoxysilane, methacroxypropyltrimethoxysilane, imidazolesilane, and triazinesilane; a fluorine-containing silane coupling agent such as CF₃(CF₂)₇CH₂CH₂Si(OCH₃)₃, CF₃(CF₂)₇CH₂CH₂SiCl₃, CF₃(CF₂)₇CH₂CH₂Si(CH₃)(OCH₃)₂, CF₃(CF₂)₇CH₂CH₂Si(CH₃)Cl₂, CF₃(CF₂)₅CH₂CH₂SiCl₃, CF₃(CF₂)₅CH₂CH₂Si(OCH₃)₃, CF₃CH₂CH₂SiCl₃, CF₃CH₂CH₂Si(OCH₃)₃, C₈F₁₇SO₂N(C₃H₇)CH₂CH₂CH₂Si(OCH₃)₃, C₇F₁₅CONHCH₂CH₂CH₂Si(OCH₃)₃, C₈F₁₇CO₂CH₂CH₂CH₂Si(OCH₃)₃, C₈F₁₇—O—CF(CF₃)CF₂—O—C₃H₆SiCl₃, and C₃F₇—O—(CF(CF₃)CF₂—O)₂—CF(CF₃)CONH—(CH₂)₃Si(OCH₃)₃; and an organosilazane compounds such as hexamethyldisilazane, hexaphenyldisilazane, trisilazane, cyclotrisilazane, and 1,1,3,3,5,5-hexamethylcyclotrisilazane.

An adhesion amount of the silane coupling agent is preferably 1 part by mass or more, more preferably 1.5 parts by mass or more, and still more preferably 2 parts by mass or more, and is preferably 10 parts by mass or less, more preferably 8 parts by mass or less, and still more preferably 5 parts by mass or less, with respect to 100 parts by mass of the hollow silica particles.

The fact that the surface of the hollow silica particles is treated with the silane coupling agent can be confirmed by detecting a peak due to a substituent group of the silane coupling agent using 1R. The adhesion amount of the silane coupling agent can be measured by an amount of carbon.

The hollow silica particles preferably have a relative permittivity at 1 GHz of 1.3 to 5.0. In particular, in the measurement of a permittivity of the powder, a sample space becomes small and a measurement accuracy deteriorates at 10 GHz or more, and thus a measurement value at 1 GHz is adopted in the present invention. When the relative permittivity at 1 GHz is within the above range, a low relative permittivity required for an electronic device can be achieved. It is substantially difficult to synthesize the hollow silica particles having a relative permittivity at 1 GHz of less than 1.3.

A lower limit of the relative permittivity at 1 GHz is preferably 1.3 or more, and more preferably 1.4 or more. An upper limit thereof is more preferably 4.5 or less, still more preferably 4.0 or less, yet still more preferably 3.5 or less, particularly preferably 3.0 or less, and most preferably 2.5 or less.

The hollow silica particles preferably have dielectric loss tangent at 1 GHz of 0.0001 to 0.05. When the dielectric loss tangent at 1 GHz is 0.05 or less, a low relative permittivity required for an electronic device can be achieved. In addition, it is substantially difficult to synthesize the hollow silica particles having dielectric loss tangent at 1 GHz of less than 0.0001.

A lower limit of the dielectric loss tangent at 1 GHz is more preferably 0.0002 or more, and still more preferably 0.0003 or more. An upper limit thereof is more preferably 0.01 or less, still more preferably 0.005 or less, even still more preferably 0.003 or less, particularly preferably 0.002 or less, further particularly preferably 0.0015 or less, and most preferably 0.0010 or less.

The relative permittivity and the dielectric loss tangent can be measured by a perturbation resonator method using a dedicated device (for example, “vector network analyzer E5063A” manufactured by a KEYCOM Corp.).

The hollow silica particles are preferably included in a range of 5% by volume to 80% by volume in the silica particle dispersion. When a content of the hollow silica particles is 5% by volume or more, desired peel strength can be imparted with a small amount of the silica particle dispersion added to the resin composition. When the content is 80% by volume or less, the viscosity of the dispersion is not excessively increased, making it easy to handle. The content of the hollow silica particles in the silica particle dispersion is more preferably 10% by volume or more, still more preferably 20% by volume or more, and is more preferably 70% by volume or less, still more preferably 60% by volume or less, and particularly preferably 50% by volume or less.

### (Silane Compound)

The silica particle dispersion of the present invention preferably includes a silane compound having at least one group selected from the group consisting of a vinyl group, a phenyl group, a phenylamino group, an alkyl group having 4 or more carbon atoms, a methacrylic group, and an epoxy group. By including the silane compound, when the silica particle dispersion is included in the resin composition, the surfaces of the hollow silica particles blend well with the resin, and thus the peel strength of the resin composition can be further increased. When the hollow silica particles are treated with the silane coupling agent, the silane compound is not necessarily added.

Examples of the silane compound include vinyl silane, phenyl silane, phenyl amino silane, hexyl silane, decyl silane, 3-methacryloxypropyltrimethoxysilane, and amino propyl silane. These may be used alone or in combination of two or more kinds thereof. Among them, from the viewpoint of interaction with the resin, a silane compound including a vinyl group, a phenyl group, a methacrylic group, an epoxy group, or a phenylamino group is preferable, a silane compound including a vinyl group, a phenyl group, a methacrylic group, or a phenylamino group is more preferable, and a silane compound including a phenyl group or a methacrylic group is still more preferable. In this case, the silica particles in the silica particle dispersion of the present invention have the improved dispersibility in liquid, and it is particularly easy to maintain a balance between the viscosity thereof and the peel strength of a molded product to be formed therefrom.

The silane compound is preferably included in a range of 0.1% by mass to 5% by mass in the silica particle dispersion. In the case where the content of the silane compound is 0.1% by mass or more, when the silica particle dispersion is included in the resin composition, the compatibility between the hollow silica particles and the resin can be improved, and the peel strength of the resin composition can be increased. When the content is 5% by mass or less, the silane compound is prevented from remaining in the composition, and the influence on the physical properties of the resin composition can be reduced. The content of the silane compound in the silica particle dispersion is more preferably 0.2% by mass or more, still more preferably 0.3% by mass or more, and particularly preferably 0.5% by mass, and is more preferably 4% by mass or less, still more preferably 3% by mass or less, and particularly preferably 2% by mass or less.

### (Organic Thixotropic Agent)

The silica particle dispersion of the present invention preferably further includes an organic thixotropic agent.

The organic thixotropic agent is added for preventing aggregation and precipitation of the hollow silica particles in the silica particle dispersion and the resin composition or slurry including the silica particle dispersion, and for improving wettability of the flux to a cured product of the resin composition or slurry.

Examples of the organic thixotropic agent include fatty acid amides (amide wax) synthesized from vegetable oil fatty acid and amine; surfactants such as fatty acid esters, polyethers, sulfated oil, and higher alcohol sulfate; polycarboxylic acid esters; polycarboxylic acid amides; and urea modified compounds, but do not include hydrogenated castor oil-based agents called castor oil wax, and oxidized polyethylene-based agents which are waxes obtained by oxidizing polyethylene and introducing polar groups. The organic thixotropic agent may be used alone or in combination of two or more types thereof.

The organic thixotropic agent is commercially available, and examples thereof include BYK (registered trademark)-R606, BYK (registered trademark)-405, BYK (registered trademark)-R605, BYK (registered trademark)-R607, BYK (registered trademark)-410, BYK (registered trademark)-411, BYK (registered trademark)-415, BYK (registered trademark)-430, BYK (registered trademark)-431, BYK (registered trademark)-7410ET, BYK (registered trademark)-7411ES (all manufactured by BYK Japan KK), Talen 1450, Talen 2000, Talen 2200A, Talen 7200-20, Talen 8200-20, Talen 8300-20, Talen 8700-20, Talen BA-600, Flownon SH-290, Flownon SH-295S, Flownon SH-350, and Flownon HR-2, Flownon HR-4AF (all manufactured by Kyoeisha Chemical Co., Ltd.).

The organic thixotropic agent is preferably included in a range of 0.01% by mass to 5% by mass in the silica particle dispersion. When the content of the organic thixotropic agent is 0.01% by mass or more, aggregation of the hollow silica particles in the dispersion is prevented, when the silica particle dispersion is stored, aggregation between the hollow silica particles is prevented, and when the silica particle dispersion is included in the resin composition, accumulation of the resin between the hollow silica particles can be prevented. Accordingly, the peel strength of the resin composition can be increased. When the content of the organic thixotropic agent is 5% by mass or less, the organic thixotropic agent is prevented from remaining in the composition, and the influence on the physical properties of the resin composition can be reduced. The content of the organic thixotropic agent in the silica particle dispersion is more preferably 0.015% by mass or more, still more preferably 0.05% by mass or more, and is more preferably 3% by mass or less, still more preferably 2.5% by mass or less, and particularly preferably 2% by mass or less.

The silica particle dispersion of the present invention may include other optional components as long as the effects of the present invention are not impaired. Examples of the optional components include other inorganic fillers such as alumina, and cured compositions.

### (Physical Properties of Silica Particle Dispersion)

The silica particle dispersion of the present invention preferably has a viscosity of 20 mPa·s to 20,000 mPa·s at 25° C. when a solid content concentration of the hollow silica particles is 50% by volume.

In the case where the silica particle dispersion has a viscosity of 20 mPa·s or more at 25° C. when a solid content concentration of the hollow silica particles is 50% by volume, settling (floating) separation of the silica can be prevented. When the viscosity is 20,000 mPa·s or less, the silica can be used while maintaining a dispersed state. The viscosity is more preferably 50 mPa·s or more, still more preferably 75 mPa·s or more, particularly preferably 100 mPa·s or more, and is more preferably 15,000 mPa·s or less, still more preferably 12,000 mPa·s or less, and particularly preferably 10,000 mPa·s or less.

### <Method for Producing Silica Particle Dispersion>

The silica particle dispersion of the present invention is obtained by dispersing powder of hollow silica particles in a solvent. The hollow silica particles may be obtained by production or commercially available hollow silica particles may be used.

Hereinafter, a method for producing hollow silica particles and a method for producing a silica particle dispersion using the same will be described.

### (Method for Producing Hollow Silica Particles)

Examples of the method for producing hollow silica particles include a method in which an oil-in-water emulsion including an aqueous phase, an oil phase, and a surfactant is used, hollow silica precursor is obtained in the emulsion, and hollow silica particles are obtained from the precursor. The oil-in-water emulsion is an emulsion having an oil phase dispersed in water, and when a silica raw material is added to the emulsion, the silica raw material is adhered to oil droplets, whereby oil core-silica shell particles can be formed.

The method for producing the hollow silica particles includes: preparing an oil-in-water emulsion including an aqueous phase, an oil phase, and a surfactant; leaving the oil-in-water emulsion to stand for 0.5 hours to 240 hours to obtain a hollow silica precursor in which a shell layer including silica is formed on an outer periphery of a core in the oil-in-water emulsion; and removing the core from the hollow silica precursor, followed by performing a heat treatment. When the hollow silica precursor is obtained, it is preferred that a first silica raw material is added to the oil-in-water emulsion to form a first-stage shell, and a second silica raw material is added to the emulsion in which the first-stage shell is formed to form a second-stage shell, thereby forming a shell layer on the outer periphery of the core.

Hereinafter, the oil-in-water emulsion is also simply referred to as an emulsion. Further, a dispersion having oil core-silica shell particles dispersed, formed by adding the first silica raw material and not having the second silica raw material added yet, and a dispersion having oil core-silica shell particles dispersed, having the second silica raw material added, may also be sometimes referred to as an emulsion. The latter dispersion having oil core-silica shell particles dispersed, having the second silica raw material added may be the same as a hollow silica precursor dispersion.

### [First-Stage Shell Formation]

First, the first silica raw material is added to an oil-in-water emulsion including an aqueous phase, an oil phase, and a surfactant to form a first-stage shell.

The aqueous phase of the emulsion mainly includes water as a solvent. The aqueous phase may further include a water-soluble organic liquid or an additive such as a water-soluble resin. A proportion of the water in the aqueous phase is preferably 50% by mass to 100% by mass, more preferably 90% by mass to 100% by mass.

The oil phase of the emulsion preferably includes a water-insoluble organic liquid which is incompatible with an aqueous phase component. The organic liquid forms droplets in the emulsion to thereby form an oil core portion of the hollow silica precursor.

Examples of the organic liquid include an aliphatic hydrocarbon such as n-hexane, isohexane, n-heptane, isoheptane, n-octane, isooctane, n-nonane, isononane, n-pentane, isopentane, n-decane, isodecane, n-dodecane, isododecane or pentadecane, a paraffin base oil which is a mixture thereof, an alicyclic hydrocarbon such as cyclopentane, cyclohexane or cyclohexene, a naphthene base oil which is a mixture thereof, an aromatic hydrocarbon such as benzene, toluene, xylene, ethylbenzene, propylbenzene, cumene, mesitylene, tetralin or styrene, an ether such as propyl ether or isopropyl ether, an ester such as ethyl acetate, n-propyl acetate, isopropyl acetate, n-butyl acetate, isobutyl acetate, n-amyl acetate, isoamyl acetate, butyl lactate, methyl propionate, ethyl propionate, butyl propionate, methyl butyrate, ethyl butyrate or butyl butyrate, a vegetable oil such as palm oil, soybean oil or rapeseed oil, or a fluorinated solvent such as a hydrofluorocarbon, a perfluorocarbon or a perfluoropolyether. Further, a polyoxyalkylene glycol to be a hydrophobic liquid at a shell forming reaction temperature may also be used. Examples thereof include polypropylene glycol (molecular weight of 1,000 or more), or a polyoxyethylene-polyoxypropylene block copolymer having a proportion of oxyethylene units of less than 20 mass % and a cloudy point (1% by mass aqueous solution) of 40° C. or lower, preferably 20° C. or lower. Among them, a polyoxypropylene-polyoxyethylene-polyoxypropylene type block copolymer is preferably used.

These may be used alone or in combination of two or more so long as a single oil phase is formed.

The organic liquid is preferably a hydrocarbon having 8 to 16 carbon atoms, particularly 9 to 12 carbon atoms. The organic liquid is selected comprehensively considering the workability, the safety against fire, separation property of the hollow silica precursor and the organic liquid, shape characteristics of the hollow silica particles, solubility of the organic liquid in water, and the like. The hydrocarbon having 8 to 16 carbon atoms may be any of linear, branched and cyclic hydrocarbons so long as the hydrocarbon is chemically stable, or may be a mixture of hydrocarbons differing in the number of carbon atoms. The hydrocarbon is preferably a saturated hydrocarbon, and more preferably a linear saturated hydrocarbon.

The organic liquid preferably has a flash point of 20° C. or higher, and more preferably 40° C. or higher. In the case where an organic liquid having a flash point of lower than 20° C. is used, countermeasures in the work environment are required for fire control due to too low flash point.

The emulsion includes a surfactant to improve emulsification stability. The surfactant is preferably water-soluble or water-dispersible, and is used preferably as added to the aqueous phase. The surfactant is preferably a nonionic surfactant.

Examples of the nonionic surfactant include the following surfactants.
Polyoxyethylene-polyoxypropylene copolymer type surfactants;
Polyoxyethylene sorbitan fatty acid ester type surfactants: polyoxyethylene sorbitan monolaurate, polyoxyethylene sorbitan monopalmitate, polyoxyethylene sorbitan monostearate, polyoxyethylene sorbitan tristearate, polyoxyethylene sorbitan monooleate;
polyoxyethylene higher alcohol ether type surfactants: polyoxyethylene lauryl ether, polyoxyethylene cetyl ether, polyoxyethylene stearyl ether, polyoxyethylene oleyl ether, polyoxyethylene octylphenol ether, polyoxyethylene nonylphenol ether;
polyoxyethylene aliphatic ester type surfactants: polyoxyethylene glycol monolaurate, polyoxyethylene glycol monostearate, polyoxyethylene glycol monooleate; and
glycerin fatty acid ester type surfactants: stearic acid monoglyceride, oleic acid monoglyceride.

Further, a polyoxyethylene sorbitol fatty acid ester type surfactant, a sucrose fatty acid ester type surfactant, a polyglycerin fatty acid ester type surfactant, a polyoxyethylene hydrogenated caster oil type surfactant or the like may also be used.

These may be used alone or in combination of two or more kinds thereof.

Among the nonionic surfactants described above, the sorbitan fatty acid ester and the polyoxyethylene-polyoxypropylene copolymer type surfactant are preferably used. The polyoxyethylene-polyoxypropylene copolymer is a block copolymer having a polyoxyethylene block (EO) and a polyoxypropylene block (PO) bonded. The block copolymer may, for example, be an EO-PO-EO block copolymer or an EO-PO block copolymer, and is preferably an EO-PO-EO block copolymer. A proportion of oxyethylene units in the EO-PO-EO block copolymer is preferably 20% by mass or more, and more preferably 30% by mass or more.

A weight average molecular weight of the polyoxyethylene-polyoxypropylene copolymer is preferably 3,000 to 27,000, and more preferably 6,000 to 19,000.

With respect to the entire polyoxyethylene-polyoxypropylene copolymer, a total amount of the polyoxyethylene block is preferably 40% by mass to 90% by mass, and a total amount of the polyoxypropylene block is preferably 10% by mass to 60% by mass.

The amount of the surfactant used varies depending upon the conditions such as the type of the surfactant, the hydrophile-lipophile balance (HILB) which is an index indicating the degree of hydrophilicity or hydrophobicity of the surfactant, and the particle diameter of the silica particles desired, and a content of the surfactant in the aqueous phase is preferably 500 ppm by mass to 20,000 ppm by mass, and more preferably 1,000 ppm by mass to 10,000 ppm by mass. When the content in the aqueous phase is 500 ppm by mass or more, the emulsion can be more stabilized. Further, when the content of the surfactant is 20,000 ppm by mass or less, the amount of the surfactant remaining in the hollow silica particles can be reduced.

The aqueous phase and the oil phase may be blended in a mass ratio of 200:1 to 5:1, preferably 100:1 to 9:1.

The method of preparing the oil-in-water emulsion is not limited to the following description. The aqueous phase and the oil phase are preliminarily prepared, and the oil phase is added to the aqueous phase, followed by sufficient mixing or stirring, whereby the oil-in-water emulsion can be prepared. Further, ultrasonic emulsification of physically applying a strong shearing force, emulsification by stirring, high pressure emulsification or the like may be employed. Further, membrane emulsification method of having the fine oil phase obtained by passing through a membrane having fine pores dispersed in the aqueous phase, phase inversion emulsification method of dissolving the surfactant in the oil phase and then adding the aqueous phase and conducting emulsification, or a phase inversion temperature emulsification method of utilizing a phenomenon that the surfactant changes from water-soluble to oil-soluble at a temperature around the cloudy point may, for example, be mentioned. The emulsification methods may be properly selected depending upon the desired particle diameter, particle diameter distribution, and the like.

In order to decrease the particle diameter of the hollow silica particles to be obtained and to narrow the particle diameter distribution, it is preferred that the oil phase is sufficiently dispersed in the aqueous phase and the mixed liquid is emulsified. For example, the mixed liquid may be emulsified by a high pressure homogenizer, preferably under a pressure of 10 bar or more, more preferably 20 bar or more.

In the first-stage shell formation step, a step of aging the obtained oil-in-water emulsion is preferably performed. By performing the aging step, the fine emulsion preferentially grows, a primary particle diameter of the hollow silica to be obtained becomes uniform, and the distribution of the primary particle diameter becomes narrow. Accordingly, the product (A×B) of the Ar density A and the BET specific surface area B can be reduced. An aging time is 0.5 hours to 240 hours. When the aging time is 0.5 hours or more, the uniformity of the particle diameter of the primary particles is increased, and when the aging time is 240 hours or less, the productivity is good. The aging time is preferably 0.5 hours to 96 hours, and most preferably 0.5 hours to 48 hours.

An aging temperature is preferably 5° C. to 80° C., more preferably 20° C. to 70° C., and most preferably 20° C. to 55° C.

In the first-stage shell formation step, the first silica raw material is added to the oil-in-water emulsion.

Examples of the first silica raw material include an aqueous solution having water-soluble silica dissolved, an aqueous dispersion having solid silica dispersed, a mixture thereof, or at least one member selected from the group consisting of an alkali metal silicate, activated silicic acid and a silicon alkoxide, or an aqueous solution or aqueous dispersion thereof. Among them, at least one member selected from the group consisting of an alkali metal silicate, activated silicic acid and a silicon alkoxide, or an aqueous solution or aqueous dispersion thereof, is preferable in view of availability.

Examples of the solid silica include silica sol obtained by hydrolyzing an organic silicon compound, or commercially available silica sol.

Examples of the alkali metal of the alkali metal silicate include lithium, sodium, potassium or rubidium, and among them, in view of availability and the cost, sodium is preferable. That is, alkali metal silicate is preferably sodium silicate. Sodium silicate has a composition represented by Na₂O·nSiO₂·mH₂O. A proportion of sodium to silicate is, by the molar ratio n of Na₂O/SiO₂, preferably 1.0 to 4.0, further preferably 2.0 to 3.5.

The activated silicic acid is one obtained by subjecting an alkali metal silicate to cation exchange treatment to replace the alkali metal with hydrogen, and the aqueous solution of the activated silicic acid is weakly acidic. For the cation exchange, a hydrogen form cation exchange resin is preferably used.

The alkali metal silicate or the activated silicic acid is preferably added to the emulsion after dissolving or dispersing in water. A concentration of the alkali metal silicate or activated silicic acid aqueous solution is, as a SiO₂ concentration, preferably 3% by mass to 30% by mass, more preferably 5% by mass to 25% by mass.

As the silicon alkoxide, for example, tetraalkoxysilanes such as tetramethoxysilane, tetraethoxysilane and tetrapropoxysilane are preferably used.

Further, by mixing other metal oxide or the like with the silica raw material, composite particles may be obtained. Examples of such other metal oxide include titanium dioxide, zinc oxide, cerium oxide, copper oxide, iron oxide or tin oxide.

As the first silica raw material, the above-described silica raw material can be used alone or in combination of two or more kinds thereof. Among them, as the first silica raw material, an alkali metal silicate aqueous solution, particularly a sodium silicate aqueous solution is preferably used.

The first silica raw material is preferably added to the oil-in-water emulsion under an acidic condition. By adding the silica raw material under an acidic environment, silica fine particles are generated to form a network, thereby forming a first-stage coating film. To maintain the stability of the emulsion, a reaction temperature is preferably 80° C. or lower, more preferably 70° C. or lower, still more preferably 60° C. or lower, particularly preferably 50° C. or lower, and most preferably 40° C. or lower. From the viewpoint of controlling a network formation rate of the silica fine particles to make a thickness of the coating film uniform, the reaction temperature is preferably 4° C. or higher, more preferably 10° C. or higher, still more preferably 15° C. or higher, particularly preferably 20° C. or higher, and most preferably 25° C. or higher.

A pH of the oil-in-water emulsion is more preferably less than 3, still more preferably 2.5 or less, and even still more preferably 1 or more, from the viewpoint of making the thickness of the coating film more uniform and making a silica shell layer of the hollow silica to be obtained denser.

In order to make the pH of the oil-in-water emulsion acidic, an acid may be added.

Examples of the acid include hydrochloric acid, nitric acid, sulfuric acid, acetic acid, perchloric acid, hydrobromic acid, trichloroacetic acid, dichloroacetic acid, methanesulfonic acid or benzenesulfonic acid.

At the time of adding the first silica raw material, as the amount of the first silica raw material added, the amount of SiO₂ in the first silica raw material is preferably 1 parts by mass to 50 parts by mass, more preferably 3 parts by mass to 30 parts by mass with respect to 100 parts by mass of the oil phase included in the emulsion.

At the time of adding the first silica raw material, after adding the first silica raw material, the pH of the emulsion is maintained to be acidic for preferably 1 minute or more, more preferably 5 minutes or more, and still more preferably 10 minutes or more.

Next, the pH of the emulsion having the first silica raw material added is preferably maintained at 3 or more and 7 or less (from weakly acidic to neutral). Accordingly, the first silica raw material can be fixed to the surface of the oil droplets.

For example, the pH of the emulsion may be kept to be 3 or more by adding a base to the emulsion having the first silica raw material added.

Examples of the base include an alkali metal hydroxide such as sodium hydroxide or potassium hydroxide, an alkaline earth metal hydroxide such as magnesium hydroxide or calcium hydroxide, ammonia or an amine.

Alternatively, a method of replacing an anion such as a halogen ion with a hydroxide ion by anion exchange treatment may be employed.

At the time of adding the base, it is preferable to gradually add the base while the emulsion having the first silica raw material added is stirred so as to gradually increase the pH of the emulsion. In the case where stirring is not intense, or a large amount of the base is added all at once, the pH of the emulsion tends to be non-uniform, and the thickness of a first layer coating film may be non-uniform.

The emulsion is preferably maintained with stirring. A retention time may be 10 minutes or more, preferably 1 hour or more, and may be 4 hours or more. To maintain the stability of the emulsion, a retention temperature is preferably 100° C. or lower, more preferably 95° C. or lower, still more preferably 90° C. or lower, and particularly preferably 85° C. or lower. To promote aging, the retention temperature is preferably 35° C. or higher, more preferably 40° C. or higher, and particularly preferably 45° C. or higher.

### [Second-Stage Shell Formation]

Next, the second silica raw material is added to the emulsion in the presence of alkali metal ions. Accordingly, the hollow silica precursor dispersion is obtained. The hollow silica precursor is in the form of oil core-silica shell particles.

The second silica raw material is preferably added to the emulsion under an alkaline condition.

At the time of adding the first silica raw material, in order to make the adhesion of the first silica raw material to the oil droplets more uniform, the method of once acidifying the emulsion and then adjusting the pH to be 3 to 7 (weakly acidic to neutral) is employed. A first silica layer obtained by such a method is porous and has insufficient denseness and thus has low strength. By alkalifying the emulsion at the time of adding the second silica raw material, a high-density second silica layer can be formed on the obtained first silica layer.

To prevent generation of new fine particles, the pH of the emulsion when the second silica raw material is added is preferably 8 or more, more preferably 8.5 or more, still more preferably 8.7 or more, particularly preferably 8.9 or more, and most preferably 9 or more. When the pH is too high, the solubility of silica increases. Therefore, the pH is preferably 13 or less, more preferably 12.5 or less, still more preferably 12 or less, particularly preferably 11.5 or less, and most preferably 11 or less.

In order to make the pH of the oil-in-water emulsion alkaline, a base may be added. As the base, the same compounds as those described above are used.

As the second silica raw material, a material similar to the first silica raw material may be used alone or in combination of two or more kinds thereof. Among them, at the time of adding the second silica raw material, at least one of the sodium silicate aqueous solution and the activated silicic acid aqueous solution is preferably used.

When the second silica raw material is added to the emulsion under the alkaline condition, a method of adding an alkali metal hydroxide simultaneously with addition of the second silica raw material may be employed. In addition, a method of using sodium silicate as the alkali metal silicate for the second silica raw material may also be employed. In such a case, the sodium silicate as an alkali component is added to the weakly acidic emulsion having the pH adjusted to be 5 or more after adding the first silica raw material, and accordingly the pH of the emulsion can be maintained to be alkaline while the second silica raw material is added. Further, the alkali metal ions are present in the emulsion.

In a case where the pH is too high, for example, in a case where the sodium silicate aqueous solution is used as the second silica raw material, an acid may be added to adjust the pH. The acid to be used may be the same acid as that used when the first silica raw material is added.

The second silica raw material is preferably added in the presence of alkali metal ions. The alkali metal ions may be derived from the first silica raw material, may be derived from the second silica raw material, or may be derived from the base added to adjust the pH, or may be incorporated, for example, by addition of an additive to the emulsion. For example, an alkali metal silicate is used as at least one of the first silica raw material and the second silica raw material. In addition, as the additive to the emulsion, a halide, sulfate, nitrate, fatty acid salt or the like of an alkali metal is used.

In the case where the second silica raw material is added, for example, at least one of the sodium silicate aqueous solution and the activated silicic acid aqueous solution may be added to the emulsion after adding the first silica raw material, or both may be added. In a case where both are added, the sodium silicate aqueous solution and the activated silicic acid aqueous solution may be added all at once, or may be added in order.

Addition of the second silica raw material may be carried out, for example, by conducting a step of adding the sodium silicate aqueous solution and a step of adding the activated silicic acid aqueous solution once or repeatedly two or more times, so as to promote adhesion of the silica raw material to the first silica layer while the pH is adjusted.

The second silica raw material is preferably added to the emulsion heated so as to promote adhesion of the silica raw material to the first silica layer. To prevent generation of new fine particles, a heating temperature is preferably 30° C. or higher, more preferably 35° C. or higher, still more preferably 40° C. or higher, particularly preferably 45° C. or higher, and most preferably 50° C. or higher. When the temperature becomes high, the solubility of silica increases. Therefore, the temperature is preferably 100° C. or lower, more preferably 95° C. or lower, still more preferably 90° C. or lower, particularly preferably 85° C. or lower, and most preferably 80° C. or lower. In the case where the heated emulsion is used, after adding the second silica raw material, the formed emulsion is preferably gradually cooled to room temperature (about 23° C.). That is, the heating temperature is preferably in a range of 30° C. to 100° C.

At the time of adding the second silica raw material, the amount of the second silica raw material added is preferably adjusted so that the amount of SiO₂ in the second silica raw material is 20 parts by mass to 500 parts by mass, more preferably 40 parts by mass to 300 parts by mass with respect to 100 parts by mass of the oil phase.

At the time of adding the second silica raw material, the pH of the emulsion is preferably maintained to be alkaline after adding the second silica raw material for 10 minutes or more.

By the addition of the first silica raw material and the addition of the second silica raw material, a total added amount of the first silica raw material and the second silica raw material is preferably adjusted so that a total amount of SiO₂ in the first silica raw material and SiO₂ in the second silica raw material is 30 parts by mass to 500 parts by mass, more preferably 50 parts by mass to 300 parts by mass with respect to 100 parts by mass of the oil phase.

The silica shell layer of the present invention may be constituted mainly by silica, and if necessary, other metal component such as Ti or Zr may be incorporated, for example, for the refractive index adjustment. The method of incorporating other metal component is not particularly limited, and for example, in the step of adding the silica raw material, the method of simultaneously adding a metal sol solution or a metal salt aqueous solution may be adopted.

The hollow silica precursor dispersion is obtained as described above.

Examples of the method of obtaining the hollow silica precursor from the hollow silica precursor dispersion include a method of subjecting the dispersion to filtration, a method of removing the aqueous phase by heating, or a method of separating the precursor by sedimentation separation or centrifugal separation.

As an example, a method of subjecting the dispersion to filtration through a filter of about 0.1 μm to about 5 μm, and drying the filtered hollow silica precursor may be mentioned.

Further, if necessary, the obtained hollow silica precursor may be washed with water, an acid, an alkali, an organic solvent or the like.

### [Heat Treatment of Hollow Silica Precursor]

The oil core is removed from the hollow silica precursor and subjected to a heat treatment. Examples of the method of removing the oil core include a method of baking the hollow silica precursor so that the oil is burnt and decomposed, a method of volatilizing the oil by drying, a method of adding an appropriate additive to decompose the oil, or a method of extracting the oil, for example, with an organic solvent. Among them, a method of baking the hollow silica precursor with low residual of oil so that the oil is burnt and decomposed is preferable.

Hereinafter, a method of baking the hollow silica precursor to remove the oil core, followed by performing a heat treatment will be described as an example.

In the method of obtaining the hollow silica particles by removing the oil core by baking the hollow silica precursor, the heat treatment is preferably performed at different temperatures in at least two stages. The oil core is removed by a first-stage heat treatment, and the shell layer of the hollow silica particles is densified by a second-stage heat treatment.

In the first-stage heat treatment, organic components of the oil core and the surfactant are removed. Since it is necessary to thermally decompose the oil in the hollow silica precursor, the first-stage heat treatment is performed at a temperature of preferably 100° C. or higher, more preferably 200° C. or higher, and most preferably 300° C. or higher. When the first-stage heat treatment is performed at an excessively high temperature, the densification of the silica shell proceeds and it is difficult to remove an organic component inside the silica shell, and therefore, the first-stage heat treatment is performed at a temperature of preferably lower than 700° C., preferably 550° C. or lower, more preferably 530° C. or lower, still more preferably 520° C. or lower, particularly preferably 510° C. or lower, and most preferably 500° C. or lower. That is, the first-stage heat treatment is preferably performed in a range of 100° C. or higher and lower than 700° C. The first-stage heat treatment may be performed once or may be performed a plurality of times. A first-stage heat treatment time is preferably 30 minutes or more, preferably 1 hour or more, and more preferably 2 hours or more, and is preferably 48 hours or less, more preferably 24 hours or less, and more preferably 12 hours or less. That is, the first-stage heat treatment time is preferably in a range of 30 minutes to 48 hours.

In the second-stage heat treatment, the shell is densified by baking the hollow silica particles. By the second-stage heat treatment, silanol groups on the particle surface can be reduced and the dielectric loss tangent can be reduced. A second-stage baking temperature is preferably higher than the first-stage heat treatment temperature.

When the second-stage heat treatment is performed by leaving to stand, the second-stage heat treatment is preferably performed at 700° C. or higher, more preferably 800° C. or higher, still more preferably 900° C. or higher, and most preferably 1,000° C. or higher. When the temperature is too high, the amorphous silica is crystallized to increase the relative permittivity. Therefore, the temperature is preferably 1,200° C. or lower, more preferably 1,150° C. or lower, and most preferably 1,100° C. or lower. That is, the second-stage heat treatment is preferably performed in a range of 700° C. to 1,200° C. The second-stage heat treatment temperature is preferably higher than the first-stage heat treatment temperature by 200° C. or higher, more preferably 200° C. to 800° C., and still more preferably 400° C. to 700° C. The second-stage heat treatment may be performed once or may be performed a plurality of times. A heat treatment time is preferably 10 minutes or more, more preferably 30 minutes or more, and is preferably 24 hours or less, more preferably 12 hours or less, and most preferably 6 hours or less. That is, the second-stage heat treatment time is preferably in a range of 10 minutes to 24 hours.

The second-stage heat treatment may use a spray combustion method. A flame temperature at that time is preferably 1,000° C. or higher, more preferably 1,200° C. or higher, and most preferably 1,400° C. or higher. Further, the flame temperature is preferably 2,000° C. or lower, more preferably 1,800° C. or lower, and most preferably 1,600° C. or lower. That is, when the spray combustion method is used for the second-stage heat treatment, the flame temperature is preferably in a range of 1,000° C. to 2,000° C.

The temperature of the hollow silica precursor may be returned to room temperature after the first-stage baking and before the second-stage heat treatment, or may be increased to the second-stage heat treatment temperature from a state in which the first-stage baking temperature is maintained.

The hollow silica particles obtained in the above step may be aggregated by the drying or baking step, and thus may be disintegrated into a handleable aggregation diameter. However, in the present invention, the hollow silica particles can be directly mixed with a solvent to obtain a silica particle dispersion.

Examples of the disintegration method include a method using a mortar, a method using a dry or wet ball mill, a method of using a sieve shaker, or a method of using a disintegrator such as a pin mill, a cutter mill, a hammer mill, a knife mill, a roller mill or a jet mill.

In this way, the hollow silica particles used in the silica particle dispersion of the present invention are obtained.

### (Preparation of Silica Particle Dispersion)

The obtained hollow silica particles are mixed with a solvent to obtain a silica particle dispersion. A method for producing a silica particle dispersion of the present invention includes mixing a solvent and powder of hollow silica particles having an average particle diameter in a range of 0.2 μm to 10 μm, and subjecting the mixed liquid to a dispersion treatment, followed by classifying to remove aggregates of the hollow silica particles.

The type and amount of the solvent, and the physical properties and amount of the hollow silica particles are as described above.

The powder of the hollow silica particles is preferably mixed in the silica particle dispersion at a proportion of 5% by volume to 80% by volume. When the proportion of the hollow silica particles is too small, the productivity of the subsequent concentration step may decrease, and when the proportion thereof is too large, the viscosity of the silica particle dispersion may increase excessively and the productivity of the dispersion treatment may decrease. Therefore, the proportion of the hollow silica particles is preferably in the range of 5% by volume to 80% by volume. The amount of the hollow silica particles used is more preferably 10% by volume or more, still more preferably 20% by volume or more, and is more preferably 60% by volume or less, still more preferably 50% by volume or less.

Regarding a dispersion treatment of the mixed liquid containing the solvent and the hollow silica particles, a dispersion device used for pigment dispersion or the like can be used. Examples thereof include a mixer such as a disper, a homomixer, or a planetary mixer, a homogenizer (“CLEARMIX” manufactured by M Technique Co., Ltd., “FILMIX” manufactured by PRIMIX Corporation, or “Abramix” manufactured by Silverson Co., Ltd.), a paint conditioner (manufactured by Red Devil, Inc.), a colloid mill (“PUC colloid mill” manufactured by PUC Inc. and “colloid mill MK” manufactured by TKA), a cone mill (“cone mill MKO” manufactured by IKA), a media type disperser such as a ball mill, a sand mill (“DYNO-MILL” manufactured by SHIMARU ENTERPRISES CORPORATION), an attritor, a pearl mill (“DCP mill” manufactured by Eirich), and a coball mill; a medialess disperser such as a wet jet mill (“Genus PY” manufactured by Genus Corporation, “STAR BURST” manufactured by Sugino Machine Limited., “Nanomizer” manufactured by NANOMIZER Inc.), “ClEAR SS-5” manufactured by M Technique Co., Ltd., and “MICROS” manufactured by Nara Machinery Co., Ltd.; and other roll mills and kneaders. In the above, a crushing media (ball, bead, or the like) is preferably not used. This is because when a crushing media is used, contamination of the worn media is concerned. Specifically, a wet jet mill (for example, “Genus PY” manufactured by Genus Corporation, “STAR BURST” manufactured by Sugino Machine Limited., “Nanomizer” manufactured by NANOMIZER Inc.), and the medialess disperser such as “ClEAR SS-5” manufactured by M Technique Co., Ltd., or “MICROS” manufactured by NARA MACHINERY CO., LTD. are desirable.

A temperature during the dispersion treatment is preferably 0° C. to 100° C. Here, the temperature during the dispersion treatment refers to a temperature range before and after the treatment. By performing the dispersion treatment in the temperature range, the viscosity of the solvent is appropriately maintained, the productivity is maintained, and evaporation of the solvent is prevented and a solid content can be easily controlled. The treatment temperature is more preferably 5° C. or higher, and still more preferably 10° C. or higher, and is more preferably 90° C. or lower, and still more preferably 80° C. or lower.

A time of the dispersion treatment may be appropriately set depending on the dispersion device to be used such that a hollow structure of the hollow silica particles is not broken, and is preferably 0.5 minutes to 60 minutes, more preferably 0.5 minutes to 10 minutes, and still more preferably 0.5 minutes to 5 minutes.

Thereafter, aggregates of the hollow silica particles remained without being dispersed even in the dispersion treatment are subjected to wet classification. The wet classification includes classification using a sieve or a centrifugal force. In the case of using the sieve, the classification is preferably performed by a sieve having an opening of 100 m or less. As the sieve, for example, a metal having a dense lattice structure such as an electroformed sieve is preferably used.

The opening of the sieve is preferably 100 μm or less, more preferably 75 μm or less, still more preferably 50 μm or less, and particularly preferably 35 μm or less. A lower limit of the opening of the sieve is preferably 0.2 μm or more, more preferably 0.5 μm or more, and still more preferably 1 μm or more. That is, the opening of the sieve is preferably in the range of 0.2 μm to 100 μm.

Thereafter, dilution or concentration may be performed as necessary to adjust a concentration to an appropriate value. Examples of the concentration method include vaporization and concentration, and solid-liquid separation.

In the method for producing a silica particle dispersion of the present invention, a silane coupling agent may be added to the mixed liquid of the solvent and the hollow silica particles. Examples of the silane coupling agent include the silane coupling agents described above.

### <Resin Composition>

The silica particle dispersion of the present invention can be mixed with a resin and used as a resin composition. The resin composition preferably includes 5 mass % to 70 mass % of the hollow silica particles, and more preferably 10 mass % to 50 mass % of the hollow silica particles.

The resin may use one or two or more types of a polyamide resin such as an epoxy resin, a silicone resin, a phenol resin, a melamine resin, a urea resin, unsaturated polyester, a fluororesin, polyimide, polyamide-imide, or polyether imide; a polyester such as polybutylene terephthalate or polyethylene terephthalate; polyphenylene sulfide, aromatic polyester, polysulfone, a liquid crystal polymer, polyethersulfone, polycarbonate, a maleimide modified resin, an ABS resin, an acrylonitrile-acrylic rubber-styrene (AAS) resin, an acrylonitrile-ethylene-propylene-diene rubber-styrene (AES) resin, a poly tetrafluoroethylene (PTFE), a tetrafluoroethylene-perfluoroalkyl vinyl ether copolymer (PFA), a tetrafluoroethylene-hexafluoropropylene copolymer (FEP), and a tetrafluoroethylene-ethylene copolymer (ETFE). Since the dielectric loss tangent in the resin composition also depends on characteristics of the resin, the resin to be used may be selected in consideration of this factor.

The resin composition may include an optional component other than the above resin. Examples of the optional component include a dispersion aid, a surfactant, and a filler other than silica.

When a resin film is produced using the resin composition of the present invention, a relative permittivity thereof at the frequency of 10 GHz is preferably 2.0 to 3.5. A lower limit of the relative permittivity at the frequency of 10 GHz is more preferably 2.2 or more, and still more preferably 2.3 or more, and an upper limit thereof is more preferably 3.2 or less, and still more preferably 3.0 or less. In the case where the relative permittivity of the resin film at the frequency of 10 GHz is within the above range, the resin film can be expected to be used for electronic devices, communication devices, and the like because of excellent electrical characteristics.

The dielectric loss tangent of the resin film at the frequency of 10 GHz is preferably 0.01 or less, more preferably 0.008 or less, and still more preferably 0.0065 or less. In the case where the dielectric loss tangent of the resin film at the frequency of 10 GHz is within the above range, the resin film can be expected to be used for electronic devices, communication devices, and the like because of excellent electrical characteristics. As the dielectric loss tangent is smaller, a transmission loss of a circuit is reduced, and thus, a lower limit value thereof is not particularly limited.

The dielectric loss tangent can be measured using a split post dielectric resonator (SPDR) (for example, manufactured by Agilent Technologies Japan, Ltd.).

The resin film preferably has an average coefficient of linear expansion of 10 ppm/° C. to 50 ppm/° C. When the average coefficient of linear expansion is in the above range, the range is close to a coefficient of thermal expansion of a copper foil widely used as a base material, and thus, the electrical characteristics are excellent. The average coefficient of linear expansion is more preferably 12 ppm/° C. or more, still more preferably 15 ppm/° C. or more, and more preferably 40 ppm/° C. or less, and still more preferably 30 ppm/° C. or less.

The average coefficient of linear expansion is determined by heating the resin film at a load of 5 N and a temperature increase rate of 2° C./min, measuring a dimensional change of a sample from 30° C. to 150° C., and calculating an average with using a thermomechanical analyzer (for example, “TMA-60” manufactured by SHIMADZU CORPORATION).

The silica particle dispersion of the present invention can be used as various fillers, and can be particularly and suitably used as a filler in resin compositions used for production of an electronic substrate used in an electronic device such as a personal computer, a laptop, and a digital camera, and a communication device such as a smartphone and a game console. Specifically, the silica particle dispersion of the present invention is expected to be applied to a resin composition, a prepreg, a metal foil-clad laminate, a printed wiring board, a resin sheet, an adhesive layer, an adhesive film, a solder resist, a bump reflow, a rewiring insulating layer, a die bond material, a sealing material, an underfill, a mold underfill, a laminated inductor, and the like in order to achieve the low permittivity, the low transmission loss, the low moisture absorption, and the improved peel strength.

### EXAMPLES

Hereinafter, the present invention will be described with reference to Examples, but the present invention is not limited thereto. In the following description, common components employ the same substance.

Examples 1 to 10 are working examples, and Examples 11 to 13 are comparative examples.

### Test Example 1

In Test Example 1, hollow silica particles and a silica particle dispersion using the obtained hollow silica particles were prepared.

### Example 1

### Preparation of Emulsion

To 1250 g of pure water, 4 g of an EO-PO-EO block copolymer (Pluronic F68 manufactured by ADEKA Corporation) was added, followed by stirring until dissolution. To the obtained aqueous solution, 42 g of n-decane having 4 g of sorbitan acid monooleate (IONET S-80 manufactured by Sanyo Chemical Industries, Ltd.) dissolved was added, followed by stirring by a homogenizer manufactured by IKA until the entire liquid became uniform to prepare a crude emulsion.

The crude emulsion was emulsified under a pressure of 50 bar by using a high pressure emulsifier (LAB 1000 manufactured by SMT CO., LTD.) to prepare a fine emulsion having an emulsion diameter of 1 μm.

### Emulsion Aging

The obtained fine emulsion was allowed to stand at 40° C. for 12 hours to obtain an aged emulsion.

### First-Stage Shell Formation

To 1,300 g of the obtained emulsion after aging, 23 g of a diluted sodium silicate aqueous solution (SiO₂ concentration of 10.4 mass %, Na₂O concentration of 3.6 mass %) and 2 M hydrochloric acid were added so as to have a pH of 2, followed by thoroughly stirring while maintaining at 30° C.

While the liquid was stirred well, 1 M sodium hydroxide aqueous solution was dropped slowly to the liquid so that the pH became 6, thereby obtaining an oil core-silica shell particle dispersion. The obtained oil core-silica shell particle dispersion was maintained and aged.

### Second-Stage Shell Formation

The entire oil core-silica shell particle dispersion obtained by the first-stage shell formation was heated to 70° C., and 1 M NaOH was added slowly with stirring to adjust the pH to 9.

Next, 330 g of a diluted sodium silicate aqueous solution (SiO₂ concentration of 10.4 mass %, Na₂O concentration of 3.6 mass %) was gradually added together with 0.5 M hydrochloric acid so as to have the pH of 9.

The obtained suspension was maintained at 80° C. for 1 day and then cooled to room temperature to obtain a hollow silica precursor dispersion.

### Filtration, Washing, Drying, and Baking

The entire hollow silica precursor dispersion was neutralized with 2 M hydrochloric acid so as to have a pH of 2, and then filtered with quantitative filter paper 5C. Thereafter, 350 ml of ion-exchanged water at 80° C. was added thereto, followed by filtration under pressure again to wash a hollow silica cake.

A cake obtained after the filtration was dried in a nitrogen atmosphere at 100° C. for 1 hour and then at 400° C. for 2 hours (temperature increase rate of 10° C./min) to remove organic components, thereby obtaining a hollow silica precursor.

The obtained hollow silica precursor was baked at 1,000° C. for 1 hour (temperature increase rate of 10° C./min) to bake a shell, thereby obtaining hollow silica baked particles.

### Dispersion in Solvent

To a 250 ml plastic bottle, 10 g of the obtained hollow silica baked particles and 200 ml of methyl ethyl ketone (MEK) were put (7% by volume of hollow silica baked particles and 93% by volume of MEK), followed by stirring at 30 rpm for 2 hours with a mixed rotor. An operation of ejecting the obtained mixed liquid from a nozzle of φ0.1 mm at a pressurized pressure of 50 MPa using a wet pulverization and dispersion device (Star Burst Mini manufactured by Sugino Machine Limited., model number: HJP-25001) was repeated three times. The obtained slurry was passed through an electroformed sieve with an opening of 10 μm to obtain a silica particle dispersion having a solid content of 6.2% by mass.

### Example 2

Example 2 was carried out under the same conditions as in Example 1 except that the amount of the EO-PO-EO block copolymer (“Pluronic F68” manufactured by ADEKA Corporation) added was changed to 2 g, and the amount of sorbitan acid monooleate (IONET S-80 manufactured by Sanyo Chemical Industries, Ltd.) added was changed to 2 g to prepare hollow silica particles.

### Example 3

Example 3 was carried out under the same conditions as in Example 1 except that the amount of EO-PO-EO block copolymer (“Pluronic F68” manufactured by ADEKA Corporation) added was changed to 10 g, and emulsification was carried out at a pressure of 100 bar to prepare hollow silica particles without using the sorbitan acid monooleate (IONET S-80 manufactured by Sanyo Chemical Industries, Ltd.), and that the slurry was passed through an electroformed sieve with an opening of 15 μm.

### Example 4

Example 4 was carried out under the same conditions as in Example 1 except that the obtained hollow silica precursor was baked at 1,100° C. for 1 hour (temperature increase rate of 10° C./min) to prepare hollow silica particles, and that the slurry was passed through an electroformed sieve with an opening of 15 μm.

### Example 5

Example 5 was carried out under the same conditions as in Example 1 except that the obtained hollow silica precursor was baked at 800° C. for 1 hour (temperature increase rate of 10° C./min) to prepare hollow silica particles.

### Example 6

Example 6 was carried out under the same conditions as in Example 1 except that the obtained hollow silica precursor was baked at 700° C. for 1 hour (temperature increase rate of 10° C./min) to prepare hollow silica particles.

### Example 7

Example 7 was carried out under the same conditions as in Example 1 except that the hollow silica precursor was filtered and washed by using 350 ml of tap water instead of ion-exchanged water.

### Example 8

To a 250 ml plastic bottle, 10 g of the hollow silica baked particles obtained in the same manner as in Example 1, 200 ml of methyl ethyl ketone (MEK), and 0.10 g of KBM-503 (3-methacryloxypropyltrimethoxysilane manufactured by Shin-Etsu Chemical Co., Ltd.) were put, followed by stirring at 30 rpm for 2 hours with a mixed rotor. An operation of heating the obtained mixed liquid at 80° C. for 1 hour, followed by cooling, and ejecting the obtained mixed liquid from a nozzle of φ0.1 mm at a pressurized pressure of 50 MPa using a wet pulverization and dispersion device (Star Burst Mini manufactured by Sugino Machine Limited, model number: HJP-25001) was repeated three times. The obtained slurry was passed through an electroformed sieve with an opening of 10 μm to obtain a silica particle dispersion having a solid content of 6.2% by mass.

### Example 9

To a 250 ml plastic bottle, 10 g of the hollow silica baked particles obtained in the same manner as in Example 1, 200 ml of methyl ethyl ketone (MEK), and 0.020 g of BYK (registered trademark)-R606 (polyhydroxycarboxylic acid ester, manufactured by BYK) were put, followed by stirring at 30 rpm for 2 hours with a mixed rotor. An operation of ejecting the obtained mixed liquid from a nozzle of φ0.1 mm at a pressurized pressure of 50 MPa using an wet pulverization and dispersion device (Star Burst Mini manufactured by Sugino Machine Limited., model number: HJP-25001) was repeated three times. The obtained slurry was passed through an electroformed sieve with an opening of 10 μm to obtain a silica particle dispersion having a solid content of 6.2 mass %.

### Example 10

A silica particle dispersion was obtained in the same manner as in Example 8 except that KBM-503 in Example 8 was changed to 0.10 g of KBM-103 (trimethoxyphenylsilane, manufactured by Shin-Etsu Chemical Co., Ltd.).

### Example 11

Example 11 was carried out under the same conditions as in Example 1 except that SO—C2 (deflagration method silica with a median diameter of 0.5 μm and solid silica, manufactured by ADMATECHS COMPANY LIMITED) was used instead of the hollow silica baked particles in Example 1, and the slurry was passed through an electroformed sieve with an opening of 30 μm.

### Example 12

Example 12 was carried out under the same conditions as in Example 1 except that iM16K (glass balloon having a median diameter of 18 μm manufactured by 3M) was used instead of the hollow silica baked particles in Example 1 and the slurry was passed through an electroformed sieve with an opening of 30 μm.

### Example 13

The hollow silica baked particles (10 g) obtained in Example 1 were used as they were.

Table 1 shows results of measuring an average particle diameter (D50), an Ar density, a He density, a specific surface area, a sphericity, and a viscosity of a 50% by volume dispersion of the hollow silica particles prepared in each example described above.

### 1. Average Particle Diameter (D50)

The hollow silica particles (secondary particles) were measured by a diffraction/scattering particle diameter distribution analyzer (MT 3300) manufactured by MicrotracBEL Corp., and the median (median diameter, D50) of the particle diameter distribution (diameter) was measured. The measurement was performed twice, and an average value was determined.

### 2. Density Measurement Using Dry Pycnometer

The density of the hollow silica particles was measured using a dry pycnometer (AccuPyc II 1340 manufactured by Micromeritics Instrument Corporation). Measurement conditions were as follows.
Sample cell: 10 cm³ cell
Sample weight: 1.0 g
Measurement gas: helium or argon
Number of times of purge: 10 times
Purge processing filling pressure: 135 kPag
Number of cycles: 10 times
Cycle filling pressure: 135 kPag
Rate at which pressure equilibrium is terminated: 0.05 kPag/min

### 3. Specific Surface Area

The hollow silica particles were dried under reduced pressure at 230° C. to completely remove water, thereby obtaining a sample. Regarding the sample, the specific surface area was measured by a multi-point BET method using a nitrogen gas in “TriStar II”, which is an automatic specific surface area and pore distribution measurement device manufactured by Micromeritics Instrument Corporation.

### 4. Sphericity

Using S4800 manufactured by Hitachi High-Tech Corporation, a scanning electron microscope (SEM) image of the hollow silica particles observed at an accelerating voltage of 5 kV was obtained. For any 100 particles from the SEM image, a diameter (DL) of each circumscribed circle and a diameter (DS) of each inscribed circle were measured, and the sphericity was determined from an average value obtained by calculating a ratio (DS/DL) of the diameter (DS) of the inscribed circle to the diameter (DL) of the circumscribed circle.

### 5. Viscosity of Silica Particle Dispersion

The viscosity of the silica particle dispersion in which the solid content concentration of the hollow silica particles was 50% by volume was measured as follows.

To a 250 ml plastic bottle, 100 ml of the hollow silica particles and 100 ml of methyl ethyl ketone (MEK) were input, followed by stirring at 30 rpm for 2 hours with a mixed rotor. However, 100 ml of the hollow silica particles was prepared by calculating a mass of the hollow silica baked particles (100×d (g)) from the density d (g/cm³). An operation of ejecting the obtained mixed liquid from a nozzle of φ0.1 mm at a pressurized pressure of 50 MPa using a wet pulverization and dispersion device (Star Burst Mini manufactured by Sugino Machine Limited, model number: HJP-25001) was repeated three times. The obtained slurry was adjusted to 25° C., a viscosity thereof was measured for 30 seconds at a shear rate of 1 rpm using a rotary rheometer (for example, a modular rheometer Physica MCR-301 manufactured by Anton Paar), and the viscosity obtained at 30 seconds was determined.

### Test Example 2

### (Preparation of Evaluation Sample A (Resin Film))

A resin film was prepared using the silica particle dispersions of Examples 1 to 12 and the hollow silica particles of Example 13.

In 13 parts by mass of methyl ethyl ketone (MEK), 25 parts by mass of a biphenyl type epoxy resin (epoxy equivalent: 276, “NC-3000” produced by Nippon Kayaku Co., Ltd.) were dissolved by heating while stirring. The obtained mixture was cooled to room temperature, and mixed with 32 parts by mass of an active ester-based curing agent (“HP 8000-65T” manufactured by DIC Corporation, active group equivalent: 223, toluene solution containing 65 mass % of non-volatile components), followed by kneading at 2,000 rpm for 5 minutes with Awatori Rentaro, mixing 0.9 parts by mass of 4-dimethylaminopyridine (DMAP) and 1.6 parts by mass of 2-ethyl-4-methyl imidazole (“2E4MZ”, manufactured by Shikoku Chemicals Corporation) as curing accelerators, and mixing at 2,000 rpm for 5 minutes using Homo disperser. The silica particle dispersion or the hollow silica particles were weighed and mixed therein so as to obtain (30×A/2.2) parts by mass of particle powder, followed by mixing at 2,000 rpm for 5 minutes using Homo disperser, where A (g/cm³) was a particle density determined by density measurement with a dry pycnometer using argon gas.

Next, a transparent polyethylene terephthalate (PET) film (“PET5011 550” manufactured by LINTEC Corporation, thickness: 50 μm) which was subjected to a mold release treatment was prepared. The obtained varnish was applied to a release-treated surface of the PET film using an applicator so as to have a thickness after drying of 40 μm, followed by drying in a gear oven at 100° C. for 10 minutes, and then cutting to prepare an uncured laminated film including an uncured resin film (B-stage film) of 200 mm in length×200 mm in width×40 μm in thickness.

The obtained uncured laminated film was heated in a gear oven set to 190° C. for 90 minutes to cure the uncured resin film, thereby preparing a cured film.

### (Preparation of Evaluation Sample B (Laminate))

### (1) Laminating Step

A single-sided roughened copper foil (F0-WS, thickness of 18 μm, surface roughness Rz=1.2 μm, manufactured by Furukawa Electric Co., Ltd.) was prepared. The uncured laminated film prepared as described above was laminated on the copper foil using a “batch type vacuum laminator MVLP-500-IIA” manufactured by MEIKI CO., LTD. such that a surface of the uncured resin film (B-stage film) faced a roughened copper foil surface, thereby obtaining a laminated structure including the copper foil/B-stage film/PET film. The lamination was performed under the following conditions: pressure reduction was performed for 30 seconds to set an atmospheric pressure to 13 hPa or less, and then pressing was performed for 30 seconds at 100° C. under a pressure of 0.8 MPa.

### (2) Film Peeling Step

The PET film of the laminated structure was peeled off.

### (3) Curing Step

A laminated plate was placed in a gear oven having an internal temperature of 180° C. for 30 minutes to cure the B-stage film, thereby forming an insulating layer.

### (Evaluation)

### 1. Measurement of Peel Strength

For the evaluation sample B, a cut was made in a strip shape on the copper foil side so as to have a width of 1 cm. The substrate was set in a 90° peel tester, a copper-plated end with the cut was picked up with a gripper, the copper plating was peeled by 20 mm, and peel strength (N/cm) was measured.

### 2. Graininess of Coated Film

The appearance of the uncured laminated film was observed to evaluate graininess of a coating film. Evaluation criteria were as follows. The evaluation of A and B was judged to be practical.

### [Evaluation Criteria]

A (good): No graininess.
B (fair): Fine irregularities were observed after coating.
C (Poor): Streaks were observed due to adhesion of coarse particles during coating.

The test results are shown in Table 1.

TABLE 1

| | | | | | | | Viscosity of | | |
|---|---|---|---|---|---|---|---|---|---|
| | | | | BET | | | dispersion | | |
| | | | | specific | | | containing 50% | | |
| | | Ar | He | surface | | Whether | by volume of | Peel | Graininess |
| | D50 | density | density | area | | dispersion | particles | strength | of coated |
| | μm | g/cm³ | g/cm³ | m²/g | Sphericity | prepared | mPa · s | N/mm | film |
| Example 1 | 1 | 0.65 | 2.15 | 12 | 0.95 | Yes | 5,500 | 65 | A |
| Example 2 | 2 | 0.45 | 2.15 | 6 | 0.95 | Yes | 4,500 | 75 | A |
| Example 3 | 7 | 1.00 | 2.15 | 60 | 0.95 | Yes | 8,000 | 90 | B |
| Example 4 | 9 | 1.50 | 2.25 | 10 | 0.95 | Yes | 2,000 | 100 | B |
| Example 5 | 1 | 0.80 | 2.05 | 44 | 0.95 | Yes | 8,500 | 55 | A |
| Example 6 | 1 | 1.20 | 1.95 | 92 | 0.95 | Yes | 9,000 | 40 | B |
| Example 7 | 5 | 0.65 | 2.15 | 15 | 0.95 | Yes | 4,000 | 60 | A |
| Example 8 | 1 | 0.65 | 2.15 | 12 | 0.95 | Yes | 4,500 | 120 | A |
| Example 9 | 1 | 0.65 | 2.15 | 12 | 0.95 | Yes | 5,000 | 90 | A |
| Example 10 | 1 | 0.65 | 2.15 | 12 | 0.95 | No | 5,200 | 70 | B |
| Example 11 | 0.5 | 2.28 | 2.28 | 5 | 0.8 | Yes | 23,500 | 20 | C |
| Example 12 | 17 | 0.45 | 0.45 | 1.7 | 0.9 | Yes | — | — | — |
| Example 13 | 1 | 0.65 | 2.15 | 12 | 0.95 | No | 21,000 | 30 | C |

From Table 1, it was found that Examples 1 to 10 had higher peel strength and stronger adhesive force than Examples 11 and 13. Further, Examples 1 to 10 had good graininess of the coated film, and all were suitable for practical use.

On the other hand, in Examples 11 and 13, the peel strength was low, and graininess of the coated film was also observed. Further, in Example 12, application and drying were performed. However, the coated film peeled off when touched with a hand, and when the coated film was observed with a microscope, the particles were broken into fragments. Therefore, further evaluation was not possible.

Although the present invention has been described in detail with reference to specific embodiments, it is apparent to those skilled in the art that various changes and modifications can be made without departing from the spirit and scope of the present invention. The present application is based on a Japanese Patent Application (No. 2022-077092) filed on May 9, 2022, the contents of which are incorporated herein by reference.

1. A silica particle dispersion comprising: hollow silica particles; and a solvent, wherein the hollow silica particles have an average particle diameter in a range of 0.2 μm to 10 μm.

2. The silica particle dispersion according to claim 1, wherein the hollow silica particles have a particle density of 0.35 g/cm³ to 2.00 g/cm³, the particle density being determined by density measurement with a dry pycnometer using argon gas.

3. The silica particle dispersion according to claim 1, wherein the hollow silica particles have a particle density of 2.00 g/cm³ to 2.30 g/cm³, the particle density being determined by density measurement with a dry pycnometer using helium gas.

4. The silica particle dispersion according to claim 1, wherein the hollow silica particles have a BET specific surface area of 1 m²/g to 100 m²/g.

5. The silica particle dispersion according to claim 1, wherein the hollow silica particles have a sphericity of 0.75 to 1.0.

6. The silica particle dispersion according to claim 1, further comprising a silane compound having at least one group selected from the group consisting of a vinyl group, a phenyl group, a phenylamino group, an alkyl group having 4 or more carbon atoms, a methacrylic group, and an epoxy group.

7. The silica particle dispersion according to claim 1, further comprising an organic thixotropic agent.

8. The silica particle dispersion according to claim 1, wherein the solvent comprises at least one selected from the group consisting of water, hydrocarbons, alcohols, acetate esters, ketones, cellosolves, glycol ethers, chlorohydrocarbons, and polar solvents.

9. The silica particle dispersion according to claim 1, having a viscosity of 20 mPa·s to 20,000 mPa·s at 25° C. when a solid content concentration of the hollow silica particles is 50% by volume.

10. A resin composition comprising the silica particle dispersion according to claim 1.

11. A method for producing a silica particle dispersion, the method comprising:
mixing a solvent and powder of hollow silica particles having an average particle diameter in a range of 0.2 μm to 10 μm; and
subjecting the mixed liquid to a dispersion treatment, followed by classifying to remove aggregates of the hollow silica particles.
